(19) United States
(12) Patent Application Publication
(10) Pub. No.: US 2024/0421710 A1
(43) Pub. Date: Dec. 19, 2024

(54) CONTROLLER HAVING ADAPTIVE ON-TIME PERIOD REGULATION FOR MULTIPHASE SWITCHING CONVERTER

(71) Applicant: Chengdu Monolithic Power Systems Co., Ltd., Chengdu (CN)

(72) Inventor: Fangyu Zhang, Hangzhou (CN)

(21) Appl. No.: 18/737,174

(22) Filed: Jun. 7, 2024

(30) Foreign Application Priority Data
Jun. 13, 2023 (CN) 202310700186.0

(51) Int. Cl. H02M 3/158; H02M 1/32

(52) U.S. Cl. CPC H02M 3/1584; H02M 1/32

(57) ABSTRACT

A controller for a multiphase switching converter has a comparison circuit, an initial ON-time generating unit, an ON-time regulation unit, and a switching control unit. The comparison circuit provides a comparison signal based on an output voltage and a reference signal. The initial ON-time generating unit provides an initial ON-time signal. The ON-time regulation unit provides an adjusted ON-time signal based on the initial ON-time signal and the comparison signal, to control an ON-time period of at least one of a plurality of switching circuits. The switching control unit provides a plurality of pulse width modulation signals to control the plurality of switching circuits based on the comparison signal and the adjusted ON-time signal. The plurality of switching circuits are turned on in sequence based on the comparison signal, and are turned off respectively based on the adjusted ON-time signal.

### CROSS-REFERENCE TO RELATED APPLICATIONS

This application claims the benefit of CN application No. 202310700186.0, filed on Jun. 13, 2023, and incorporated herein by reference.

### BACKGROUND OF THE INVENTION

### 1. Field of the Invention

The present invention generally refers to electrical circuits, and more particularly but not exclusively refers to multiphase switching converters.

### 2. Description of Related Art

Recently, with emergence of high-performance processors, switching converters with smaller output voltage and larger output current are needed, with higher and higher requirements on thermal performance and transient response. Multiphase switching converters are widely used because of their superior performance. Generally the multiphase switching converter comprises a plurality of switching circuits, and outputs of the plurality of switching circuits are coupled together to provide an output voltage to a load.

In order to achieve fast load transient response, constant ON-time control is used in multiphase switching converters. However, with increase of the number of phases and enhancement of the switching frequency of the multiphase switching converter, how to set up a stable and reliable multiphase switching converter with constant ON-time control is a challenge.

### SUMMARY OF THE INVENTION

It is an object of the present invention to provide a controller for a multiphase switching converter, and a control method thereof.

One embodiment of the present invention discloses a controller for a multiphase switching converter. The controller comprises a comparison circuit, an initial ON-time generating unit, an ON-time regulation unit, and a switching control unit. The comparison circuit is configured to provide a comparison signal based on an output voltage of the multiphase switching converter and a reference signal. The initial ON-time generating unit is configured to provide an initial ON-time signal. The ON-time regulation unit is configured to provide an adjusted ON-time signal based on the initial ON-time signal and the comparison signal, to control an ON-time period of at least one of a plurality of switching circuits of the multiphase switching converter. The switching control unit is configured to provide a plurality of pulse width modulation signals to control the plurality of switching circuits based on the comparison signal and the adjusted ON-time signal. The switching control unit is configured to turn on the plurality of switching circuits in sequence based on the comparison signal, and turn off the plurality of switching circuits respectively based on the adjusted ON-time signal.

Another embodiment of the present invention discloses a controller for a multiphase switching converter. The controller comprises a comparison circuit and a programmable circuit. The comparison circuit is configured to provide a comparison signal based on an output voltage of the multiphase switching converter and a reference signal. The programmable circuit is configured to provide a plurality of pulse width modulation signals to control a plurality of switching circuits of the multiphase switching converter. The programmable circuit is configured to turn on the plurality of switching circuits in sequence based on the comparison signal, and turn off the plurality of switching circuits respectively based on an initial ON-time period and a time interval between turning on two successive switching circuits. In response to the time interval being shorter than a regulation period, an ON-time period of at least one of the plurality of switching circuits is regulated based on the time interval. In response to the time interval being longer than the regulation period, the ON-time period of at least one of the plurality of switching circuits is controlled to be equal to the initial ON-time period.

Yet another embodiment of the present invention discloses a control method for a multiphase switching converter. Providing a comparison signal based on an output voltage of the multiphase switching converter and a reference signal. Providing an initial ON-time signal to control an initial ON-time period. Adjusting an ON-time period of at least one of the plurality of switching circuits from the initial ON-time period based on a time interval between turning on two successive switching circuits. Turning on the plurality of switching circuits in sequence based on the comparison signal. Turning off the plurality of switching circuits respectively in response to the ON-time period.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically illustrates a multiphase switching converter 100 in accordance with an embodiment of the present invention.

FIG. 2 illustrates a control method 200 for the multiphase switching converter 100 in accordance with an embodiment of the present invention.

FIG. 3 shows a timing diagram of the multiphase switching converter 100 in accordance with an embodiment of the present invention.

FIG. 4A schematically illustrates an ON-time regulation unit 23A in accordance with an embodiment of the present invention.

FIG. 4B schematically illustrates an ON-time regulation unit 23B in accordance with an embodiment of the present invention.

FIG. 5 schematically illustrates a switching control unit 24A in accordance with an embodiment of the present invention.

FIG. 6 schematically illustrates a controller 20A in accordance with an embodiment of the present invention.

FIG. 7 illustrates a control method 700 for a multiphase switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

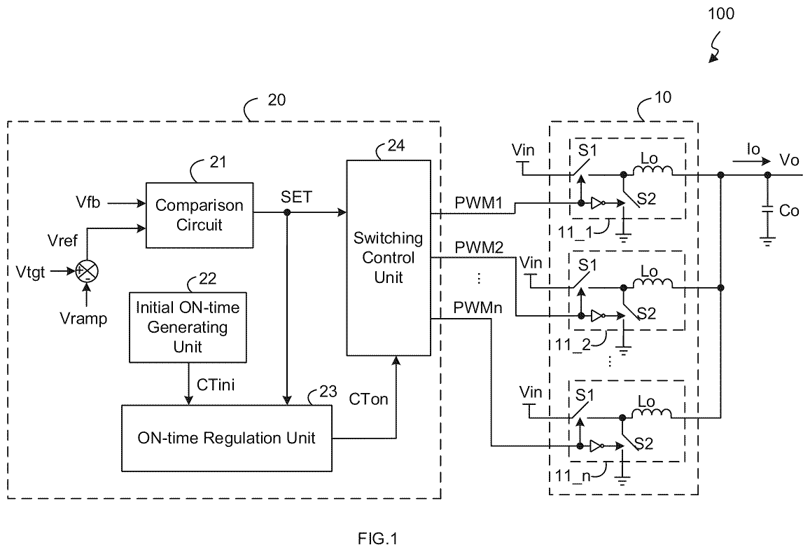

FIG. 1 schematically illustrates a multiphase switching converter 100 in accordance with an embodiment of the present invention. The multiphase switching converter 100 receives an input voltage Vin, provides an output voltage Vo and an output current Io to a load. As shown in FIG. 1, the multiphase switching converter 100 comprises a power circuit 10 having a plurality of switching circuits 11_1-11_n coupled in parallel, and a controller 20. N is a natural number greater than 1, and represents a number of the switching circuits, i.e., a phase number of the multiphase switching converter 100. Each switching circuit forms one phase of the multiphase switching converter 100. The controller 20 comprises a comparison circuit 21, an initial ON-time generating unit 22, an ON-time regulation unit 23, and a switching control unit 24.

The comparison circuit 21 is configured to provide a comparison signal SET based on a reference signal Vref and a feedback signal Vfb representative of the output voltage Vo. In the embodiment shown in FIG. 1, the reference signal Vref is equal to a target voltage Vtgt minus a ramp compensation signal Vslope as one example. The target voltage Vtgt represents a target of the output voltage Vo that the multiphase switching circuit 100 provides. In another embodiment, the ramp compensation signal Vslope may also be added to the feedback signal Vfb.

The initial ON-time generating unit 22 is configured to provide an initial ON-time signal CTini to control an initial ON-time period Tini of each switching circuit, so as to control an ON-time period TON of each switching circuit (e.g., the ON-time period of at least one switch in each switching circuit) during steady-state of the multiphase switching converter 100 (e.g., when the output current Io and the output voltage Vo are substantially stable). In one embodiment, the initial ON-time period Tini is constant. In another embodiment, the initial ON-time period Tini varies with at least one of a preset switching period Ts, the input voltage Vin, and the target voltage Vtgt. The preset switching period Ts represents an expected switching period of each of the switching circuits 11_1-11_n during steady-state of the multiphase switching converter 100.

The ON-time regulation unit 23 is configured to provide an adjusted ON-time signal CTon based on the initial ON-time signal CTini and the comparison signal SET, so as to adjust the ON-time period TON of at least one of the plurality switching circuits 11_1-11_n from the initial ON-time period Tini based on a period Tset of the comparison signal SET. In one embodiment, when the feedback signal Vfb is less than the reference signal Vref, the comparison signal SET transits to a first state from a second state (e.g., transits to a high voltage level from a low voltage level) to turn on at least one of the switching circuits 11_1-11_n, and the period Tset is a time interval between two successive transiting edges (e.g., rising edges) of the comparison signal SET. In some examples, a voltage level between a high threshold voltage (e.g., 2V) and a voltage source VCC (e.g., 3.3V) is considered as the high voltage level, a voltage level between zero voltage (0 V) and a low threshold voltage (e.g., 1V) is considered as a low voltage level. In one embodiment, the switching circuits 11_1-11_n are configured to be turned on in sequence based on the comparison signal SET, and the period Tset also indicates a time interval between turning on two successive switching circuits. In one embodiment, in response to the period Tset being longer than a regulation period Tadj, the ON-time period TON is set to be equal to the initial ON-time period Tini. In one embodiment, in response to the period Tset being shorter than the regulation period Tadj, the ON-time regulation unit 23 adjusts the ON-time period TON to get it to vary with the period Tset. For example, the ON-time period TON decreases with an increase of the period Tset, and the ON-time period TON increases with a decrease of the period Tset. In one embodiment, the regulation period Tadj is determined by the preset switching period Ts, e.g., the regulation period Tadj is set to be shorter than the preset switching period Ts divided by n, that is Tadj<Ts/n.

The switching control unit 24 is configured to provide a plurality of pulse width modulation signals PWM1-PWMn to control the plurality of switching circuits 11_1-11_n. The switching control unit 24 is configured to turn on the plurality of switching circuits 11_1-11_n in sequence based on the comparison signal SET, and turn off the plurality of switching circuits 11_1-11_n respectively based on the adjusted ON-time signal CTon.

Compared with prior arts, the multiphase switching circuit 100 according to embodiments of the present invention utilizes more flexible control scheme, which could achieve real-time adjustment of the ON-time period TON of the plurality of switching circuits 11_1-11_n based on the period Tset of the comparison signal SET. For example, when the period Tset of the comparison signal SET decreases due to some factors such as a load adding event, power supply ability of the multiphase switching converter 100 is ensured by extending the ON-time period TON, especially when a switching frequency fs of each of the switching circuits 11_1-11_n is ultrahigh, e.g., higher than 2 MHz. As a result, the multiphase switching converter 100 could respond to the load adding event in a timely manner. Furthermore, the ON-time period TON adjusted based on the period Tset improves feedback control of the output voltage, such that the output voltage Vo could be more stable. In addition, setting the regulation period Tadj can further improve robustness of the multiphase switching converter 100 and reduce fluctuation of the switching frequency fs.

Each switching circuit may comprise a buck circuit, a boost circuit, a buck-boost circuit and so on. The embodiment shown in FIG. 1 employs the buck circuit topology as an example. Referring to FIG. 1, each switching circuit comprises a high-side switch S1, a low-side switch S2, and an output inductor Lo. A first terminal of the high-side switch S1 is configured to receive the input voltage Vin, a second terminal of the high-side switch S1 is coupled to a first terminal of the low-side switch S2 and a first terminal of the output inductor Lo, a second terminal of the low-side switch S2 is coupled to a reference ground GND, and a second terminal of the output inductor Lo is coupled to an output capacitor Co to provide the output voltage Vo. The high-side switch S1 and the low-side switch S2 could be turned on complementarily under control of the corresponding pulse width modulation signal, with appropriate deadtime incorporated to avoid cross conduction. For example, the pulse width modulation signal PWM1 is configured to complementarily turn on the high-side switch S1 and the low-side switch S2 of the switching circuit 11_1, the pulse width modulation signal PWM2 is configured to complementarily turn on the high-side switch S1 and the low-side switch S2 of the switching circuit 11_2, and the pulse width modulation signal PWMn is configured to complementarily turn on the high-side switch S1 and the low-side switch S2 of the switching circuit 11_n. In one embodiment, turning on the switching circuit comprises turning on the corresponding high-side switch S1, and turning off the switching circuit comprises turning off the corresponding high-side switch S1. In one embodiment, the ON-time period of the switching circuit comprises the ON-time period of the corresponding high-side switch S1.

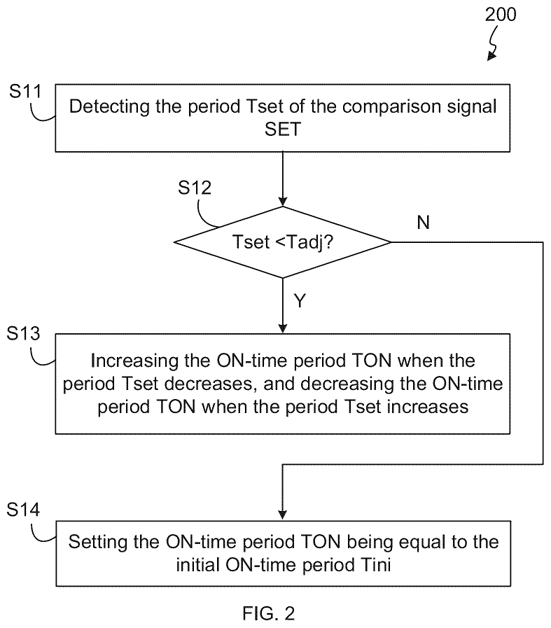

FIG. 2 illustrates a control method 200 for the multiphase switching converter 100 in accordance with an embodiment of the present invention. The control method 200 is to adjust the ON-time period of the switching circuits 11_1-11_n based on the period Tset of the comparison signal SET. The control method 200 comprises the steps S11-S14.

At the step S11, detecting the period Tset of the comparison signal SET. At the step S12, judging if the period Tset is shorter than the regulation period Tadj. If yes, then goto the step S13. At the step S13, increasing the ON-time period TON when the period Tset decreases, and decreasing the ON-time period TON when the period Tset increases. Otherwise, if the period Tset is longer than the regulation period Tadj, then goto the step S14. At the step S14, Setting the ON-time period TON being equal to the initial ON-time period Tini.

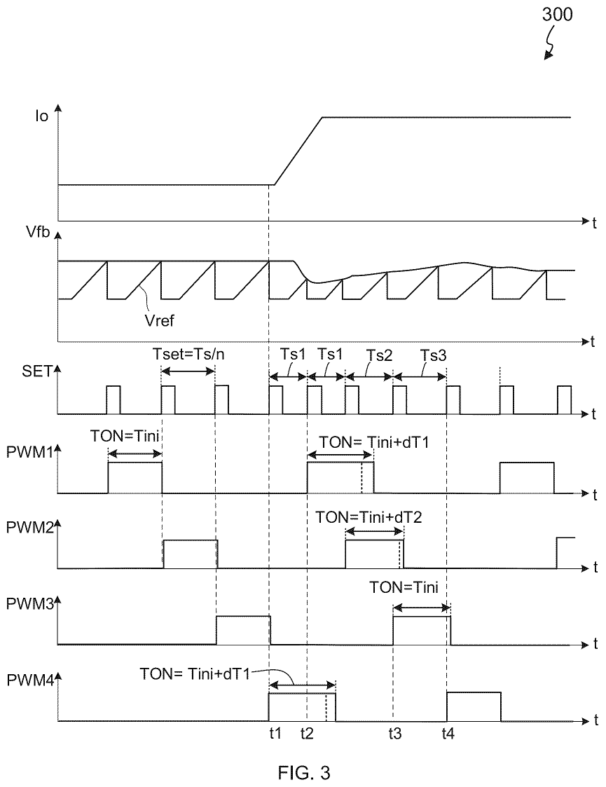

FIG. 3 shows a timing diagram of the multiphase switching converter 100 in accordance with an embodiment of the present invention. In FIG. 3, the phase number n is four, and the multiphase switching converter 100 has four switching circuits 11_1-11_4 as one example. One with ordinary skill in the art should also understand that the phase number n could also be less than or larger than 4. From top to bottom, FIG. 3 shows the output current Io, the feedback signal Vfb, the comparison signal SET, the pulse width modulation signals PWM1-PWM4. As shown in FIG. 3, the comparison signal SET is generated via comparing the feedback signal Vfb with the reference signal Vref, to turn on the switching circuits 11_1-11_4 in sequence (e.g., the switching circuits 11_1-11_4 are turned on in turns to achieve phase interleaving). Before time t1, the multiphase switching converter 100 operates in steady-state, the ON-time period TON of each switching circuit is controlled to be equal to the initial ON-time period Tini. The period Tset of the comparison signal SET is same as a preset comparison period Ts/n, i.e., dividing the preset switching period Ts by n. The period Tset also indicates the time interval between turning on two successive switching circuits as shown in FIG. 3. From time t1, the output current Io increases (e.g., the load adding event happens), and then the feedback signal Vfb decreases, the period Tset rapidly decreases accordingly, that is the time interval between turning on two successive switching circuits decreases rapidly. At time t2, the period Tset is detected to decrease to a value Ts1 which is shorter than the regulation period Tadj, that is the time interval between turning on the switching circuit 11_4 and turning on the switching circuit 11_1 as shown in FIG. 3 is shorter than the regulation period Tadj. Then the ON-time period TON of the currently turned on switching circuit 11_4 is controlled to increase to be longer than the initial ON-time period Tini, e.g., the ON-time period TON of the switching circuit 11_4 is controlled to be equal to sum of the initial ON-time period Tini and a modulation period dT1 (Tini+dT1). At time t3, the period Tset is detected to increase to the value Ts2 from the value Ts1, that is the time interval between turning on the switching circuit 11_2 and turning on the switching circuit 11_3 as shown in FIG. 3 increases compared to the previous time interval between turning on the switching circuit 11_1 and turning on the switching circuit 11_2. Then the ON-time period TON of the currently turned on switching circuit 11_2 is controlled to decrease to sum of the initial ON-time period Tini and a modulation period dT2 (Tini+dT2). The modulation period dT2 is shorter than the modulation period dT1. At time t4, the period Tset is detected to increase to a value Ts3 which is longer than the regulation period Tadj, that is the time interval between turning on the switching circuit 11_3 and turning on the switching circuit 11_4 as shown in FIG. 3 is longer than the regulation period Tadj. Then the ON-time period TON of the currently turned on switching circuit 11_3 is controlled to be equal to the initial ON-time period Tini.

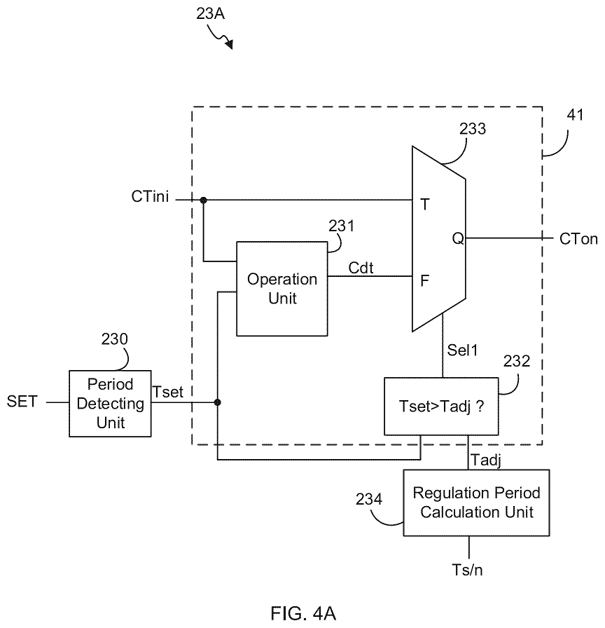

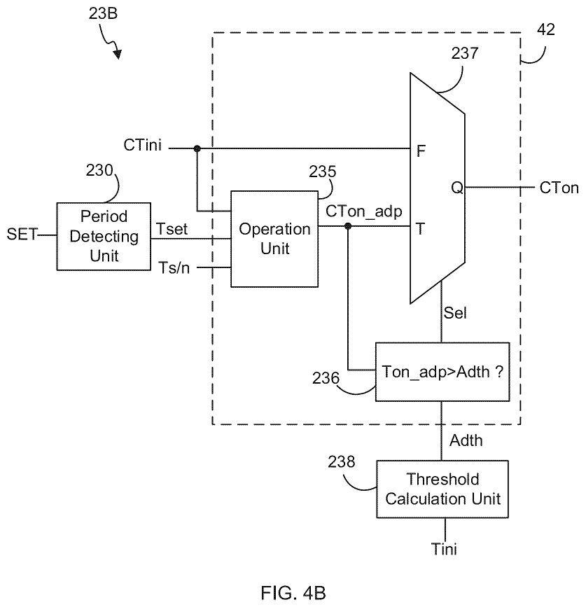

FIG. 4A schematically illustrates an ON-time regulation unit 23A in accordance with an embodiment of the present invention. In the embodiment shown in FIG. 4A, the ON-time regulation unit 23A comprises a period detecting unit 230 and an ON-time calculation unit 41. The period detecting unit 230 is configured to detect the period Tset of the comparison signal SET. The period detecting unit 230 may employ a timer or a capacitor for timing. The ON-time calculation unit 41 is configured to provide the adjusted ON-time signal CTon based on the period Tset and the initial ON-time signal CTini. When the period Tset is shorter than the regulation period Tadj, the adjusted ON-time signal CTon is configured to control the ON-time period TON being equal to sum of the initial ON-time period Tini and a modulation period dT (i.e., TON=Tini+dT). The shorter the period Tset is, the longer the modulation period dT is. When the period Tset is longer than the regulation period Tadj, the adjusted ON-time signal is configured to control the ON-time period TON being equal to the initial ON-time period Tini.

Referring to FIG. 4A, the ON-time calculation unit 41 comprises an operation unit 231, a comparison unit 232, and a selection unit 233. The operation unit 231 is configured to provide an adjustment signal Cdt based on the initial ON-time signal CTini and the period Tset. The comparison unit 232 is configured to provide a selection signal Sel1 by comparing the period Tset with the regulation period Tadj. The selection unit 233 is configured to select one of the initial ON-time signal CTini and the adjustment signal Cdt as the adjusted ON-time signal CTon in response to the selection signal Sel1. When the period Tset is longer than the regulation period Tadj, the selection unit 233 is configured to choose the initial ON-time signal CTini as the ON-time signal CTon, such that the ON-time period TON is controlled to be equal to the initial ON-time period Tini. When the period Tset is shorter than the regulation period Tadj, the selection unit 233 is configured to choose the adjustment signal Cdt as the ON-time signal CTon to control the ON-time period TON being equal to sum of the initial ON-time period Tini and the modulation period dT. In one embodiment, the modulation period dT is controlled to vary with the period Tset, e.g., is controlled to decrease when the period Tset increases, and controlled to increase when the period Tset decreases.

In one embodiment, the ON-time regulation unit 23A further comprises a regulation period calculation unit 234. The regulation period calculation unit 234 is configured to calculate the regulation period Tadj based on the preset comparison period Ts/n. In one embodiment, the regulation period Tadj is shorter than the preset comparison period Ts/n, e.g., is equal to 0.8 times the preset comparison period Ts/n (i.e., Tadj=0.8 Ts/n).

FIG. 4B schematically illustrates an ON-time regulation unit 23B in accordance with an embodiment of the present invention. In the embodiment shown in FIG. 4B, the ON-time regulation unit 23B comprises the period detecting unit 230, and an ON-time calculation unit 42. The period detecting unit 230 is configured to detect the period Tset of the comparison signal SET. The ON-time calculation unit 42 is configured to provide the adjusted ON-time signal CTon based on the period Tset, the initial ON-time signal CTini, and the preset switching period Ts of the plurality of switching circuits. In one embodiment, the ON-time calculation unit 42 is configured to provide a temporary ON-time signal CTon_adp based on the period Tset, the initial ON-time signal CTini, and the preset comparison period Ts/n which is obtained from the preset switching period Ts. When a temporary ON-time period Ton_adp represented by the temporary ON-time signal CTon_adp is longer than an adjusting threshold Adth, the ON-time calculation unit 42 is configured to set the adjusted ON-time signal CTon to be equal to the temporary ON-time signal CTon_adp, such that the ON-time period TON is controlled to be equal to the temporary ON-time period Ton_adp. When the temporary ON-time period Ton_adp represented by the temporary ON-time signal CTon_adp is shorter than the adjusting threshold Adth, the ON-time calculation unit 42 is configured to set the adjusted ON-time signal CTon to be equal to the initial ON-time signal CTini, such that the ON-time TON is controlled to be equal to the initial ON-time period Tini.

In the embodiment shown in FIG. 4B, the ON-time calculation unit 42 comprises an operation unit 235, a comparison unit 236, and a selection unit 237. The operation unit 235 is configured to provide the temporary ON-time signal CTon_adp based on the initial ON-time signal CTini, the period Tset, and the preset comparison period Ts/n. For example, the temporary ON-time period Ton_adp may be obtained by a following equation (1). One with ordinary skill in the art should understand that the temporary ON-time period Ton_adp may also be obtained by other suitable equation.

$$Ton\_adp = Tini * ( Ts / n ) / Tset \qquad ( 1 )$$

The comparison unit 236 is configured to provide a selection signal Sel via comparing the temporary ON-time period Ton_adp with the adjusting threshold Adth. The selection unit 237 is configured to select one of the initial ON-time signal CTini and the temporary ON-time signal CTon_adp as the ON-time signal CTon in response to the selection signal Sel. For example, when the temporary ON-time period Ton_adp is longer than the adjusting threshold Adth, the selection unit 237 is configured to choose the temporary ON-time signal CTon_adp as the ON-time signal CTon, otherwise the selection unit 237 is configured to choose the initial ON-time signal CTini as the ON-time signal CTon.

In one embodiment, the ON-time regulation unit 23B further comprises a threshold calculation unit 238. The threshold calculation unit 238 is configured to provide the adjusting threshold Adth based on the initial ON-time period Tini. In one embodiment, the adjusting threshold Adth is set longer than the initial ON-time period Tini. For example, the adjusting threshold Adth is equal to 1.2 times the initial ON-time period Tini (i.e., Adth=1.2Tini).

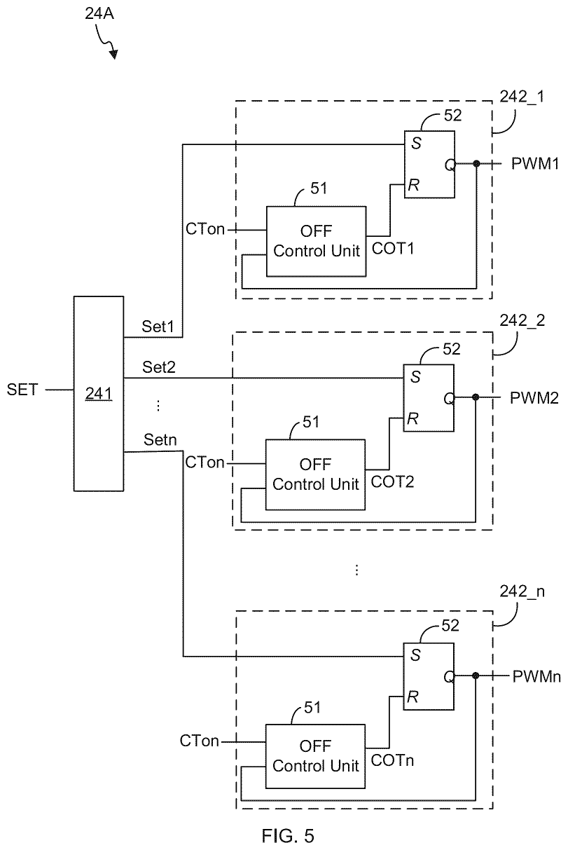

FIG. 5 schematically illustrates a switching control unit 24A in accordance with an embodiment of the present invention. As shown in FIG. 5, the switching control unit 24A comprises a frequency division unit 241 and a plurality of pulse width modulation units 242_1-242_n. The frequency division unit 241 is configured to receive the comparison signal SET, and is configured to provide a plurality of set signals Set1-Setn based on the comparison signal SET to turn on the switching circuits 11_1-11_n in sequence. The pulse width modulation units 242_1-242_n are configured to receive the set signals Set1-Setn and the ON-time signal CTon, and configured to provide the pulse width modulation signals PWM1-PWMn respectively. For example, the pulse width modulation unit 242_1 is configured to provide the pulse width modulation signal PWM1 to control the switching circuit 11_1 based on the set signal Set1 and the ON-time signal CTon, the pulse width modulation unit 242_2 is configured to provide the pulse width modulation signal PWM2 to control the switching circuit 11_2 based on the set signal Set2 and the ON-time signal CTon, and the pulse width modulation unit 242_n is configured to provide the pulse width modulation signal PWMn to control the switching circuit 11_n based on the set signal Setn and the ON-time signal CTon.

In one embodiment, each pulse width modulation unit comprises an OFF control unit 51 and an RS flip-flop 52. Take the pulse width modulation unit 242_1 as an example for illustration. The OFF control unit 51 is configured to provide an OFF control signal COT1 based on the ON-time signal CTon and the pulse width modulation signal PWM1. The OFF control signal COT1 is configured to control a time period that the pulse width modulation signal PWM1 maintains the first state (e.g., the high voltage level), so as to control the ON-time period of the switching circuit 11_1. A set terminal of the RS flip-flop 52 is configured to receive the set signal Set1, a reset terminal R of the RS flip-flop 52 is configured to receive the OFF control signal COT1, and an output terminal Q of the RS flip-flop 52 is configured to provide the pulse width modulation signal PWM1. The pulse width modulation signal PWM1 transits to the first state to turn on the switching circuit 11_1 based on the set signal Set1, and transits to the second state (e.g., the low voltage level) to turn off the switching circuit 11_1 based on the OFF control signal COT1.

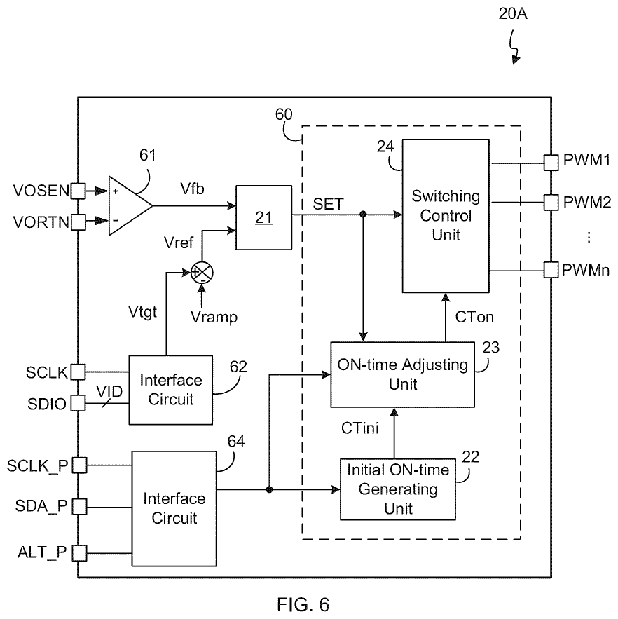

FIG. 6 schematically illustrates a controller 20A in accordance with an embodiment of the present invention. In one example, the controller 20A is integrated on an Integrated Circuit (IC), comprising switching control pins PWM1-PWMn to provide the pulse width modulation signals PWM1-PWMn, a remote feedback pin VOSEN, a remote return pin VORTN, and communication pins SCLK_P, SDA_P, ALT_P, SCLK, and SDIO. As shown in FIG. 6, the controller 20A comprises a programmable circuit 60. A shown in FIG. 6, the programmable circuit 60 is configured to provide the pulse width modulation signals PWM1-PWMn. In one embodiment, the programmable circuit 60 is configured to turn on the switching circuits 11_1-11_n in sequence based on the comparison signal SET, and configured to turn off the switching circuits 11_1-11_n respectively based on the initial ON-time period Tini and the time interval between turning on two successive switching circuits. In response to the time interval being shorter than the regulation period Tadj, the ON-time period TON is regulated based on the time interval, e.g., the ON-time period TON is controlled to decrease when the time interval increases, and controlled to increase when the time interval decreases. In response to the time interval being longer than the regulation period Tadj, the ON-time period TON is controlled to be equal to the initial ON-time period Tini. In one embodiment, in response to the time interval being shorter than the regulation period Tadj, the ON-time period TON is controlled to be equal to the initial ON-time period Tini adding the modulation period dT. In one embodiment, the modulation period dT is controlled to increase when the time interval decreases, and controlled to decrease when the time interval increase. The programmable circuit 60 may be a Field Programmable Gate Array (FPGA), a Complex Programmable Logic Device (CPLD), a Microprogrammed Control Unit (MCU), etc. In one embodiment, the programmable circuit 60 is employed to implement the initial ON-time generating unit 22, the ON-time regulation unit 23, and the switching control unit 24.

In one embodiment, the remote feedback pin VOSEN and the remote return pin VORTN are coupled across the output capacitor Co to sense the output voltage Vo. In one embodiment, the controller 20A comprises a differential amplifier 61. The differential amplifier 61 comprises two input terminals coupled to the remote feedback pin VOSEN and the remote return pin VORTN respectively, and an output terminal to provide the voltage feedback signal Vfb.

In one embodiment, the controller 20A further comprises an interface circuit 62. The interface circuit 62 is coupled to the communication pins SCLK and SDIO to receive a voltage identification code VID to set the output voltage Vo. The interface circuit 62 is configured to provide the target voltage Vtgt based on the voltage identification code VID. In one embodiment, the controller 20A further comprises an interface circuit 64 coupled to the communication pins SCLK_P, SDA_P, and ALT_P to receive user settings via a communication bus to set circuit parameters of a multiphase switching converter, such as at least one of the output voltage Vo, the output sequence, the switching frequency fs, the initial ON-time period Tini, the preset switching period Ts, and the number n of phases, etc. The interface circuit 64 may comprise, for example, a power management bus (PMBus) interface circuit, a system management bus (SMBus) interface circuit, etc.

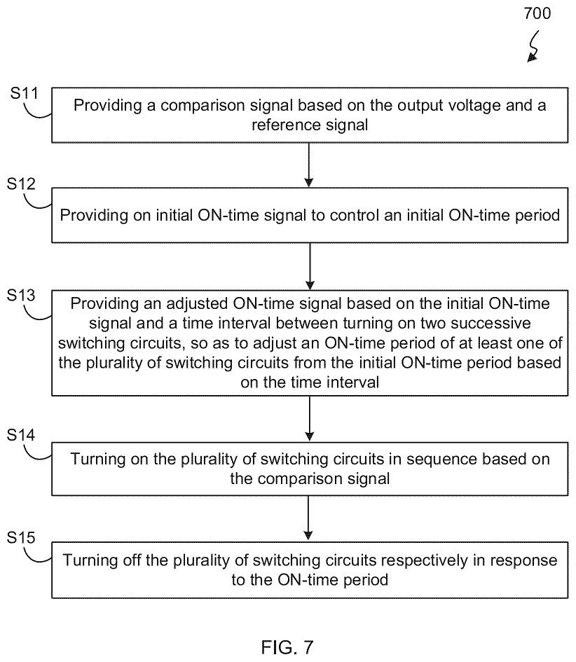

FIG. 7 illustrates a control method 700 for a multiphase switching converter in accordance with an embodiment of the present invention. The control method 700 comprises steps S11-S15. The multiphase switching converter comprises a plurality of switching circuits coupled in parallel to provide an output voltage.

At the step S11, providing a comparison signal based on the output voltage of the multiphase switching converter and a reference signal. At the step S12, providing an initial ON-time signal to control an initial ON-time period. At the step S13, providing an adjusted ON-time signal based on the initial ON-time signal and a time interval between turning on two successive switching circuits, so as to adjust an ON-time period of at least one of the plurality of switching circuits from the initial ON-time period based on the time interval. In one embodiment, the time interval is indicated by the period of the comparison signal. At the step S14, turning on the plurality of switching circuits in sequence based on the comparison signal. And at the step S15, turning off the plurality of switching circuits respectively in response to the ON-time period. In one embodiment, in response to the time interval being shorter than a regulation period, the ON-time period is regulated based on the time interval, e.g., the ON-time period is controlled to decrease when the time interval increases, and controlled to increase when the time interval decreases. In one embodiment, in response to the time interval being shorter than the regulation period, the ON-time period is controlled to be equal to the initial ON-time period adding a modulation period. The modulation period may be controlled to increase when the time interval decreases, and controlled to be decrease when the time interval increases. In one embodiment, in response to the time interval being longer than the regulation period, the ON-time period is controlled to be equal to the initial ON-time period. In one embodiment, the regulation period is determined by a preset switching period of the plurality of switching circuits.

Note that in the control methods described above, the functions indicated in the boxes can also occur in different orders than those shown in FIG. 2 and FIG. 7. Fox example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A controller for a multiphase switching converter, comprising:
a comparison circuit configured to provide a comparison signal based on an output voltage of the multiphase switching converter and a reference signal;
an initial ON-time generating unit configured to provide an initial ON-time signal;
an ON-time regulation unit configured to provide an adjusted ON-time signal based on the initial ON-time signal and the comparison signal, to control an ON-time period of a plurality of switching circuits of the multiphase switching converter; and
a switching control unit configured to provide a plurality of pulse width modulation signals to control the plurality of switching circuits based on the comparison signal and the adjusted ON-time signal, wherein the switching control unit is configured to turn on the plurality of switching circuits in sequence based on the comparison signal, and turn off the plurality of switching circuits respectively based on the adjusted ON-time signal.

2. The controller of claim 1, wherein in response to a period of the comparison signal being shorter than a regulation period, the ON-time period of at least one of the plurality of switching circuits is controlled to be varied with the period of the comparison signal.

3. The controller of claim 2, wherein in response to the period of the comparison signal being longer than the regulation period, the ON-time period of at least one of the plurality of switching circuits is controlled to be equal to an initial ON-time period, wherein the initial ON-time period is determined by the initial ON-time signal.

4. The controller of claim 2, wherein the regulation period is shorter than a preset switching period of the plurality of switching circuits divided by n, where n is a number of the plurality of switching circuits.

5. The controller of claim 1, wherein in response to a period of the comparison signal being shorter than a regulation period, the ON-time period of at least one of the plurality of switching circuits is controlled to decrease when the period of the comparison signal increases, and controlled to increase when the period of the comparison signal decreases.

6. The controller of claim 1, wherein the ON-time regulation unit comprises:
a period detecting unit configured to detect a period of the comparison signal; and
an ON-time calculation unit configured to provide the adjusted ON-time signal based on the period of the comparison signal and the initial ON-time signal; wherein
in response to the period of the comparison signal being shorter than a regulation period, the ON-time period of at least one of the plurality of switching circuits is controlled to be equal to a sum of the initial ON-time period and a modulation period.

7. The controller of claim 6, wherein the modulation period is controlled to increase when the period of the comparison signal decreases, and controlled to decrease when the period of the comparison signal increases.

8. The controller of claim 1, wherein the ON-time regulation unit comprises:
a period detecting unit configured to detect a period of the comparison signal; and
an ON-time calculation unit configured to provide the adjusted ON-time signal based on the period of the comparison signal, the initial ON-time signal, and a preset switching period of the plurality of switching circuits.

9. The controller of claim 8, wherein the ON-time calculation unit is configured to provide a temporary ON-time signal based on the period of the comparison signal, the initial ON-time signal, and a preset comparison period which is determined by the preset switching period of the plurality of switching circuits, and wherein if a temporary ON-time period represented by the temporary ON-time signal is longer than an adjusting threshold, the ON-time calculation unit is configured to set the adjusted ON-time signal to be equal to the temporary ON-time signal.

10. A controller for a multiphase switching converter, comprising:
a comparison circuit configured to provide a comparison signal based on an output voltage of the multiphase switching converter and a reference signal; and
a programmable circuit configured to provide a plurality of pulse width modulation signals to control a plurality of switching circuits of the multiphase switching converter, wherein the programmable circuit is configured to turn on the plurality of switching circuits in sequence based on the comparison signal, and configured to turn off the plurality of switching circuits respectively based on an initial ON-time period and a time interval between turning on two successive switching circuits; wherein
in response to the time interval being shorter than a regulation period, an ON-time period of at least one of the plurality of switching circuits is regulated based on the time interval; and wherein
in response to the time interval being longer than the regulation period, the ON-time period of at least one of the plurality of switching circuits is controlled to be equal to the initial ON-time period.

11. The controller of claim 10, wherein in response to the time interval being shorter than the regulation period, an ON-time period of at least one of the plurality of switching circuits is controlled to decrease when the time interval increases, and controlled to increase when the time interval decreases.

12. The controller of claim 11, wherein the regulation period is determined by a preset switching period of the plurality of switching circuits.

13. The controller of claim 10, further comprising:
an interface circuit, configured to receive user settings via a communication bus to set the output voltage, a preset switching period of the plurality of switching circuits, and a number of the plurality of switching circuits.

14. The controller of claim 10, wherein the programmable circuit is configured to control the initial ON-time period based on a preset switching period of the plurality of switching circuits.

15. The controller of claim 10, wherein in response to the time interval being shorter than the regulation period, an ON-time period of at least one of the plurality of switching circuits is controlled to be equal to the initial ON-time period adding a modulation period.

16. The controller of claim 15, wherein the modulation period is controlled to increase when the time interval decreases, and controlled to decrease when the time interval increases.

17. A control method for a multiphase switching converter, comprising:
providing a comparison signal based on an output voltage of the multiphase switching converter and a reference signal;
providing an initial ON-time signal to control an initial ON-time period;
adjusting an ON-time period of at least one of the plurality of switching circuits from the initial ON-time period based on a time interval between turning on two successive switching circuits;
turning on the plurality of switching circuits in sequence based on the comparison signal; and
turning off the plurality of switching circuits respectively in response to the ON-time period.

18. The control method of claim 17, wherein:
in response to the time interval being shorter than a regulation period, the ON-time period is controlled to decrease when the time interval increases, and controlled to increase when the time interval decreases; and
in response to the time interval being longer than the regulation period, the ON-time period is controlled to be equal to the initial ON-time period.

19. The control method of claim 17, wherein the regulation period is determined by a preset switching period of the plurality of switching circuits.
